(19) United States
(12) Patent Application Publication
(10) Pub. No.: US 2026/0169802 A1
(43) Pub. Date: Jun. 18, 2026

(54) EFFICIENTLY ALLOCATING HARDWARE RESOURCES TO SOFTWARE

(71) Applicant: SAP SE, Walldorf (DE)

(72) Inventor: Fei Yuan, Chengdu (CN)

(21) Appl. No.: 18/980,626

(22) Filed: Dec. 13, 2024

(51) Int. Cl. G06F 9/50

(52) U.S. Cl. CPC G06F 9/5027; G06F 2209/501

(57) ABSTRACT

If the sizing for an application is incorrect, either too many resources are allocated for the application or too few. Traditionally, sizing is based on answers to a questionnaire, assumptions, data gathered after the application is deployed, or various combinations thereof. As discussed herein, directed testing is used to gather information about the hardware requirements of the application. The gathered information is used along with quality of service information to accurately size the application. A load unit component performs load testing of the application to find a linear dependence of the application on hardware resources for one or more dimensions of demand on the application. Based on the data gathered by the load unit component, a multi-variable linear regression is performed to determine a resource unit for the application and a number of instances of the resource unit to be allocated to the application.

### TECHNICAL FIELD

The subject matter disclosed herein generally relates to efficient allocation of hardware resources to software.

### BACKGROUND

Sizing a software application means determining hardware requirements such as memory, central processing unit (CPU) power, disk space, input/output (I/O) capacity, and network bandwidth. The software application is deployed to hardware that meets the determined hardware requirements in order to meet business requirements such as handling a certain number of requests per second.

Initial sizing, before a software application is first deployed, is based on user-supplied data such as a number of concurrent users, an expected CPU usage per request, and the like. Empirical data is not gained until after the software application is deployed. Thus, the initial sizing for the application may not be accurate.

### BRIEF DESCRIPTION OF THE DRAWINGS

FIG. 1 shows a network diagram illustrating an example network environment suitable for efficiently allocating hardware resources to software.

FIG. 2 shows a block diagram of components of an application server suitable for efficiently allocating hardware resources to software, according to some example embodiments.

FIG. 3 shows tables of example load testing results, suitable for use in efficiently allocating hardware resources to software.

FIG. 4 shows a table of example load testing results, suitable for use in efficiently allocating hardware resources to software.

FIG. 5 shows a table of example load testing results, suitable for use in efficiently allocating hardware resources to software.

FIG. 6 shows an example user interface, suitable for use in efficiently allocating hardware resources to software.

FIG. 7 shows an example user interface, suitable for use in efficiently allocating hardware resources to software.

FIG. 8 shows a flowchart illustrating a method of efficiently allocating hardware resources to software, according to some example embodiments.

FIG. 9 shows a block diagram showing one example of a software architecture for a computing device.

FIG. 10 shows a block diagram of a machine in the example form of a computer system within which instructions may be executed for causing the machine to perform any one or more of the methodologies discussed herein.

### DETAILED DESCRIPTION

Example methods and systems are directed to efficiently allocating hardware resources to software. Allocation of hardware resources to a software application is also referred to as “sizing.” If the sizing for an application is incorrect, either too many resources are allocated for the application or too few. If too many resources are allocated to the application, costs incurred are higher than necessary. If too few resources are allocated to the application, performance of the application is negatively affected. Traditionally, sizing is based on answers to a questionnaire, assumptions, data gathered after the application is deployed, or various combinations thereof. As discussed herein, directed testing is used to gather information about the hardware requirements of the application. The gathered information is used along with quality of service information to accurately size the application.

A load unit component performs load testing of the application to find a linear dependence of the application on hardware resources (e.g., memory, CPU, or both) for one or more dimensions of demand (e.g., number of threads, request size, load size, or any suitable combination thereof) on the application. Based on the data gathered by the load unit component, a multi-variable linear regression is performed to determine a resource unit for the application and a number of instances of the resource unit to be allocated to the application.

A user interface may be presented that identifies the resource unit (e.g., a 4 CPU server with 8 GB of RAM) and the determined number of resource units (e.g., 10). A modification to the resource unit, the number of resource units, or both, may be received via the user interface. The hardware resources may be allocated to the software application according to the selections made in the user interface.

Using the systems and methods disclosed herein, sizing for an application is performed based on empirical data gathered during testing, prior to deployment. As a result, the performance of the application better complies with requirements than using previous sizing methods.

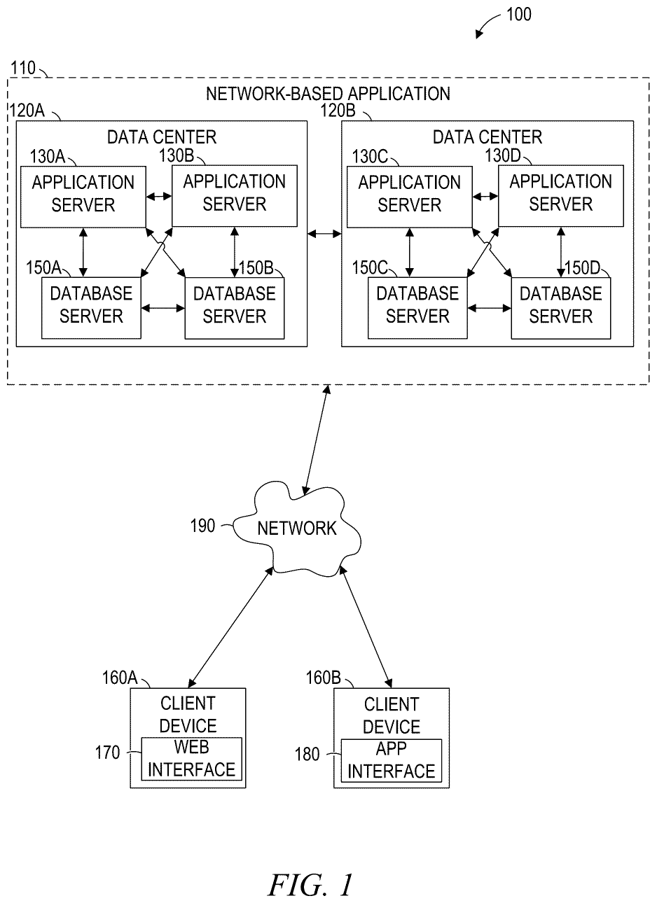

FIG. 1 shows a network diagram illustrating an example network environment 100 suitable for efficiently allocating hardware resources to software. The network environment 100 includes a network-based application 110, client devices 160A and 160B, and a network 190. The network-based application 110 may be deployed to the data center 120A, deployed to the data center 120B, or be integrated across two the data centers 120A and 120B. The data center 120A comprises application servers 130A and 130B in communication with database servers 150A and 150B. The data center 120B comprises application servers 130C and 130D in communication with database servers 150C and 150D. An application executing on the application servers 130A-130B may access data from the database servers 150A-150B. Similarly, an application executing on the application servers 130C-130D may access data from the database servers 150C-150D. The letter suffixes of reference numbers may be omitted when doing so does not raise ambiguity. For example, the application servers 130A-130D may be referred to collectively as “application servers 130.” Similarly, when the specific one of the application servers 130A-130D is not of particular import, “application server 130” may be referenced.

The application executing in the data center 120A may communicate with the application executing in the data center 120B to form an integrated application. The integrated application may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface for the application may be presented using a web interface 170 or an app interface 180.

The application servers 130 may communicate with the database servers 150 using a representational state transfer (REST) API, the Open Data Protocol (ODATA), or another API. The data may be described in metadata that provides contextual information related to the data. Metadata includes column names, data types and data relationships. If the values are from a fixed dataset, the dataset may be loaded and the loaded information used as a table description.

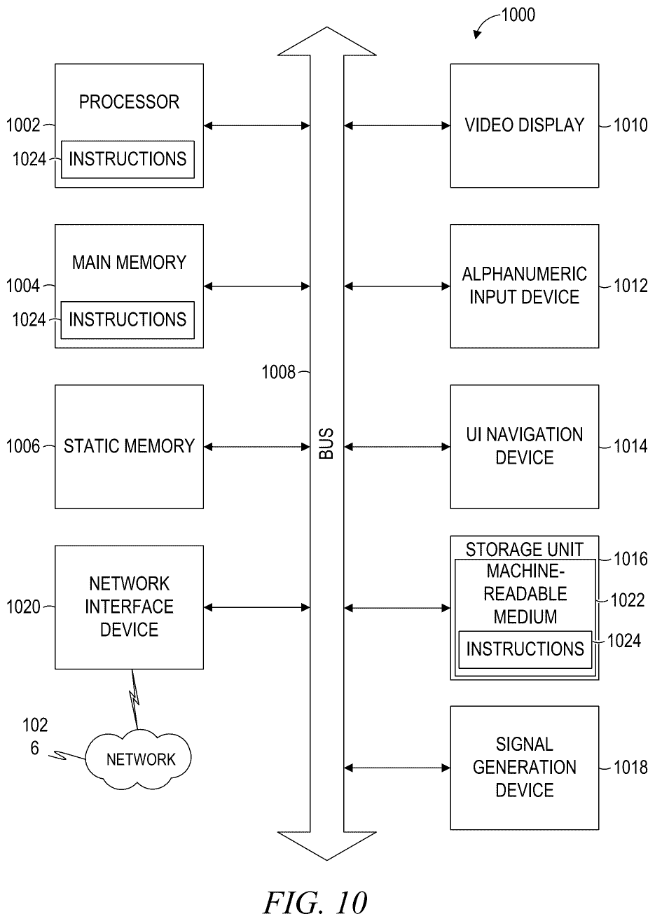

The application servers 130A-130D, the database servers 150A-150D, and the client devices 160A-160B may each be implemented in a computer system, in whole or in part, as described below with respect to FIG. 10. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130D, the database servers 150A-150D, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or a few of each element (e.g., four application servers 130A-130D, two client devices 160A and 160B, and the like), any number of each element is contemplated. For example, the application server 130A may be one of dozens or hundreds of active and standby servers and provide services to millions of client devices.

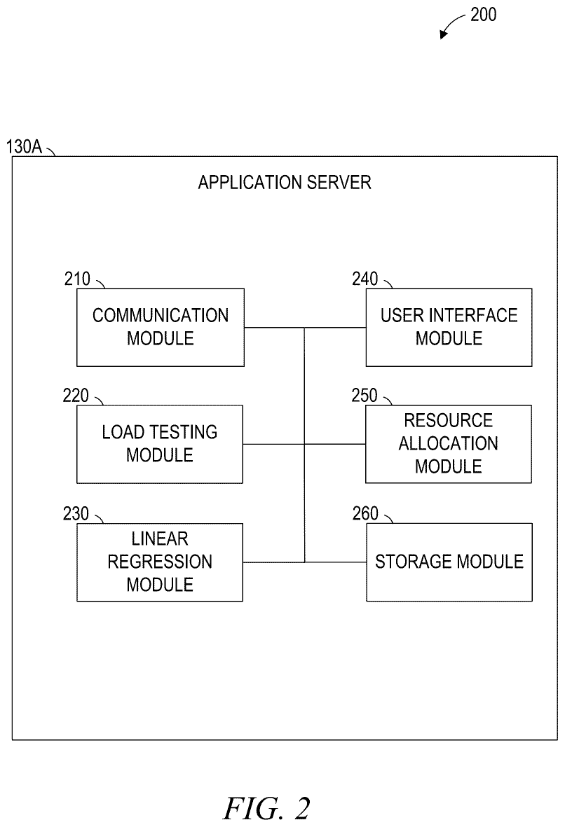

FIG. 2 shows a block diagram of components of the application server 130A suitable for efficiently allocating hardware resources to software, according to some example embodiments. The application server 130A is shown as including a communication module 210, a load testing module 220, a linear regression module 230, a user interface module 240, a resource allocation module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may send a user interface (e.g., hypertext markup language [HTML] for rendering in a web browser) from the user interface module 240 to the client device 160A.

The load testing module 220 configures and tests an instance of an application. For example, an instance of an application may be started and tested with a certain number of threads, a certain request size, and so on. While the application is being tested, hardware resource consumption by the application (e.g., CPU usage percentage, memory usage percentage, and the like) may be measured by the load testing module and stored by the storage module 260.

The linear regression module 230 performs linear regression on data gathered by the load testing module 220. Thus, linear relationships between test configurations (e.g., number of threads, request size, application data, or any suitable combination thereof) and hardware resource consumption may be determined.

The user interface module 240 may cause a user interface to be presented that allows a user to select an application to test, to configure tests for the application, to view results generated by the load testing module 220 or the linear regression module 230, or any suitable combination thereof.

Based on the linear regressions, the resource allocation module 250 allocates hardware resources to the application. For example, the load testing module 220 may make a series of tests wherein the application is loaded with 0.1% to 1.0% of the planned load for the deployed allocation. The linear regression module 230 determines a relationship between the load and the resources consumed by the application. The resource allocation module 250 determines, based on the planned load and the determined relationship, the hardware resources that will be consumed by the application at the planned load and allocates the resources accordingly.

Data, metadata, documents, instructions, or any suitable combination thereof may be stored and accessed by the storage module 250. For example, local storage of the application server 130A, such as a hard drive, may be used. As another example, network storage may be accessed by the storage module 250 via the network 190.

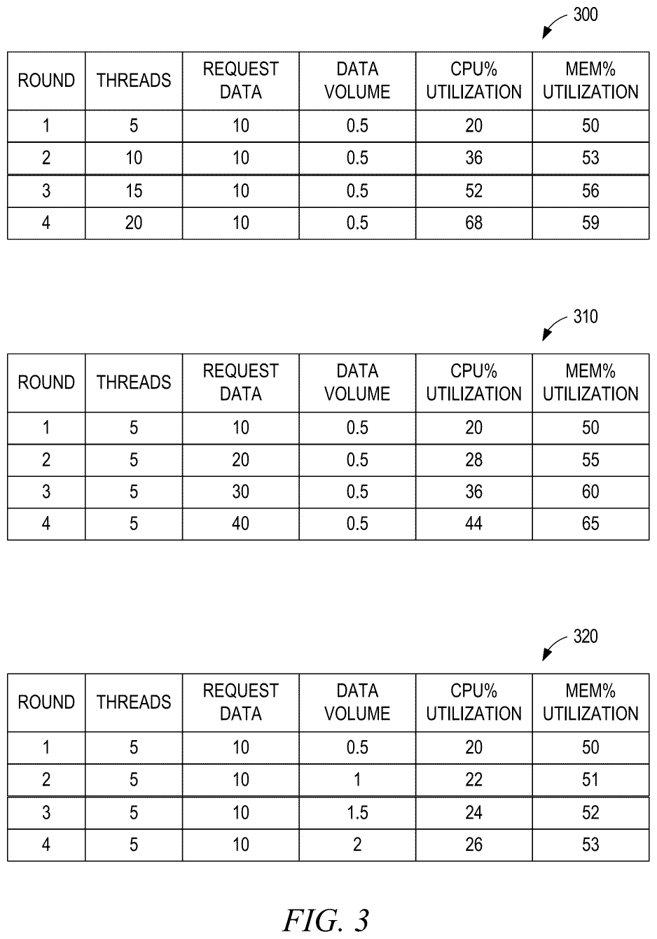

FIG. 3 shows tables 300, 310, and 320 of example load testing results, suitable for use in efficiently allocating hardware resources to software. Each of the tables 300-320 shows tests results for a series of rounds. In the table 300, each round has the same request data size (in kilobytes) and data volume (in petabytes), but a different number of threads. In the table 310, each round has the same number of threads and the same data volume, but a different request data size. In the table 320, each round has the same number of threads and the same request data size, but a different data volume.

During each test round, the CPU % utilization and the memory % utilization are measured and stored in one of the tables 300-320. Using the data in the table 300, the linear regression module 230 of FIG. 2 may determine linear relationships between the number of threads (as input) and the CPU % utilization and the memory % utilization (as outputs). Similarly, using the data in the table 310, hardware resource consumption as a function of request data size is determined, and using the data in the table 320, hardware resource consumption as a function of data volume is determined.

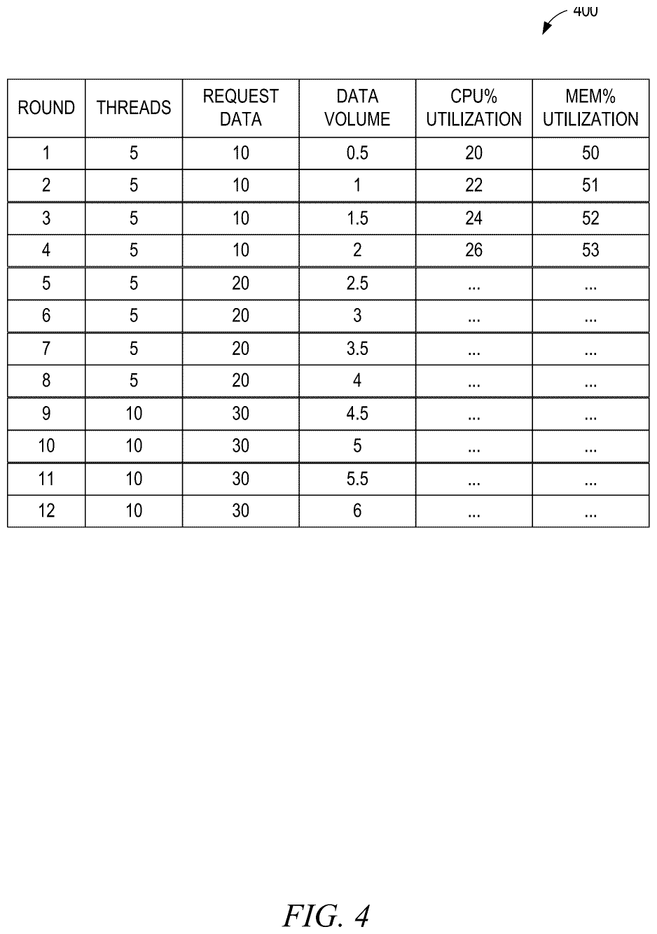

FIG. 4 shows a table 400 of example load testing results, suitable for use in efficiently allocating hardware resources to software. Using the linear relationships determined from the data in FIG. 3, two or more of the load testing variables (e.g., number of threads, request data size, data volume, and the like) are sorted based on the slope of the linear relationships. For example, the table 300 shows that, for each 5 threads added, the CPU % utilization increases by an average of 16 and the MEM % utilization increases by an average of 3. The table 310 shows that, for each 10 kb increase in request data size, the CPU % utilization increases by an average of 8 and the MEM % utilization increases by an average of 5. The table 320 shows that, for each 0.5 Pb of data volume, the CPU % utilization increases by an average of 2 and the MEM % utilization increases by an average of 1. Sorting, from highest to lowest, by the CPU % utilization slope gives a load testing variable order of: threads, request data, data volume. Sorting, from highest to lowest, by the MEM % utilization slope gives a load testing variable order of: request data, threads, data volume.

The slopes of hardware resource consumption may be combined to yield a single value for each load testing variable. For example, the slopes may be summed, averaged (e.g., using a mean or geometric mean), or a weighted average determined. Using a weighted average that gives a 60% weight to the CPU % utilization and a 40% weight to the MEM % utilization, the combined slope for each load testing variable is: threads, 10.8; request data, 6.8; data volume, 1.6. The ratio of the slopes of each pair of adjacent load testing variables is determined, and rounded to the nearest integer. In this example, the ratio of the thread slope to the request data slope is 1.588, rounded to 2; the ratio of the request data slope to the data volume slope is 4.25, rounded to 4.

For a first series of rounds, the load testing variables with the largest slopes are held constant, at the lowest values used in the testing to generate the data of FIG. 3. The load testing variable with the smallest slope is modified between rounds by the step size used in the testing to generate the data of FIG. 3. The number of rounds in the first series is the integer slope ratio determined between the load testing variable with the smallest slope and the load testing variable with the next smallest slope. Thus, in this example, the number of rounds in the first series is four, and the data volume is modified between rounds while the number of threads and request data size is held constant.

The load testing variable with the next smallest slope is modified before proceeding with a second series of rounds. The value is modified by the step size used in the testing to generate the data of FIG. 3. Accordingly, in this example, the request data size is increased from 10 kb to 20 kb between rounds four and five. During the second series of rounds, again, only the load testing variable with the smallest slope is modified. The number of rounds in the second series is equal to the number of rounds in the first series.

This process is repeated until a number of series of rounds equal to the integer ratio of the load testing variable with the second smallest slope to the load testing variable with the third smallest slope is performed. In this example, that ratio is two. After these series of rounds are completed, the load testing variable with the third smallest slope is modified by the step size used in the testing to generate the data of FIG. 3. Accordingly, in this example, the number of threads is increased from 5 to 10 between rounds eight and nine.

In this manner, testing continues until one or more of the hardware resource consumption values reaches a predetermined threshold. For example, testing may stop when either CPU % utilization reaches 90% or MEM % utilization reaches 80%. The amount of load for a single hardware computing instance is determined to be the values of the load testing variables in the final (or one before final) round.

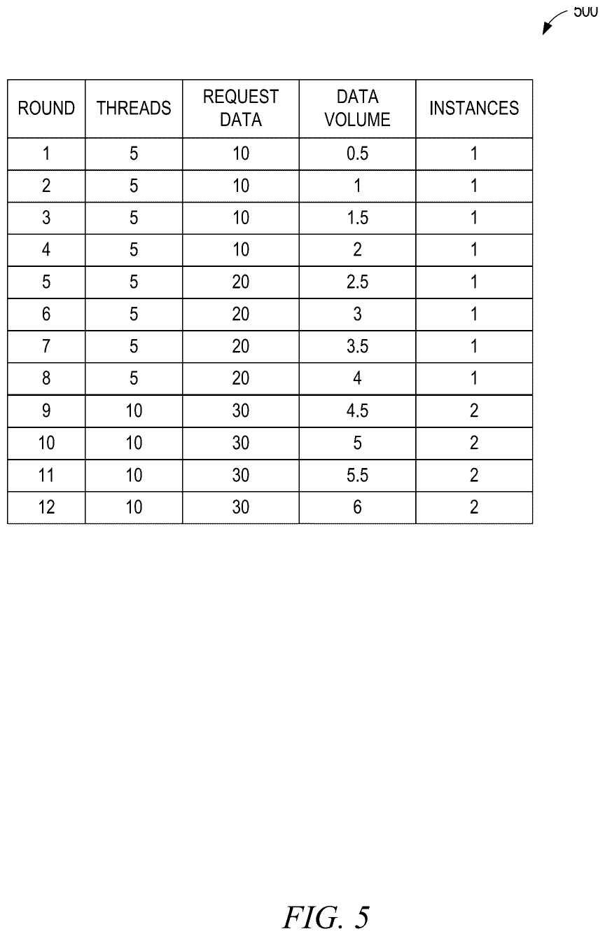

FIG. 5 shows a table of example load testing results 500, suitable for use in efficiently allocating hardware resources to software. The load testing variable values in the load testing results 500 are the same as the load testing variable values in the table 400 of FIG. 4. However, instead of showing the hardware resource consumption of individual components, a number of instances is shown.

For example, if the testing of FIG. 4 stopped after round eight because one or more of the hardware resource consumption values reached a corresponding predetermined threshold in round eight, the number of instances used in the first eight rounds is one. The number of instances used with a greater load than in round eight, but no more than double that load, is two, and so on. Thus, using the data gathered in the table 400 of FIG. 4, a number of instances can be calculated for any projected load.

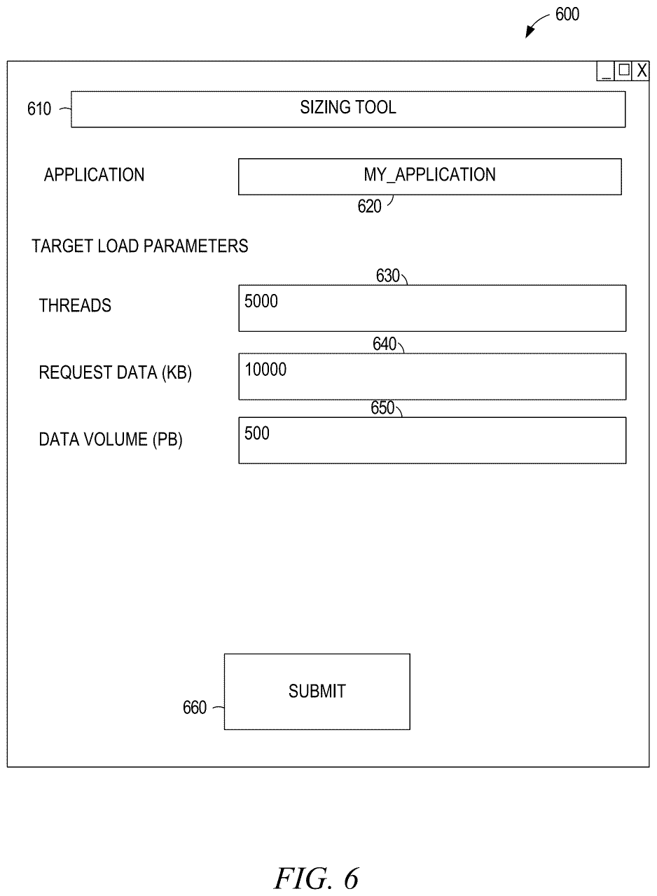

FIG. 6 shows an example user interface 600, suitable for use in efficiently allocating hardware resources to software. The user interface 600 includes a title 610, input fields 620, 630, 640, and 650, and a button 660. The user interface 600 may be generated by the user interface module 240 of FIG. 2 and presented on a display device of the client device 160A of FIG. 1.

The title 610 indicates that the user interface 600 is for a sizing tool. The input fields 620-650 receive, from a user, a name of an application being sized and one or more target load parameters for the application. In this example, the MY APPLICATION application is being sized and the target load parameters are 5000 threads using a request data size of 10,000 kb and a data volume of 500 Pb. The button 660 is operable to submit the sizing request. In response to detecting operation of the button 660, the load testing module 220 and the linear regression module 230 may perform load testing to generate the data of FIGS. 3 and 4.

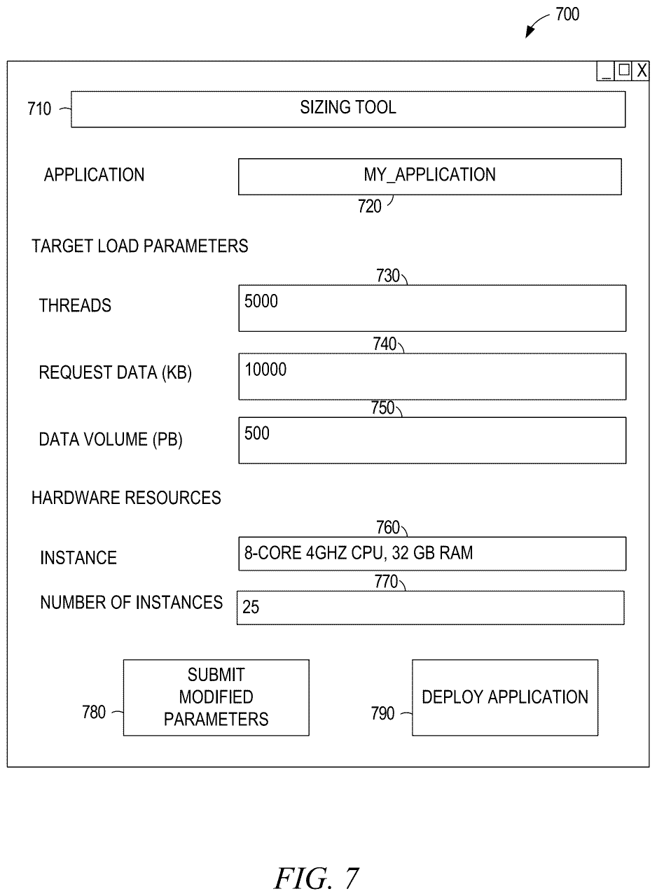

FIG. 7 shows an example user interface 700, suitable for use in efficiently allocating hardware resources to software. The user interface 700 includes a title 710; fields 720, 730, 740, 750, 760, and 770; and buttons 780 and 790. The user interface 700 may be generated by the user interface module 240 of FIG. 2 and presented on a display device of the client device 160A of FIG. 1 in response to submission of a sizing request via the user interface 600 of FIG. 6. The fields 720-770 may be input/output fields that display values when the user interface 700 is presented (providing output) and are modifiable by a user (receiving input).

The title 710 indicates that the user interface 700 is for a sizing tool. The fields 730-750 may be pre-populated with values submitted via the user interface 600. The fields 760 and 770 show the results of the sizing request. The field 760 shows technical details for each server instance that will be used for the application of the field 720. In this example, each server instance includes an 8-core 4 GHz CPU and 32 GB of RAM. The field 770 shows the number of server instances that will be used for the application (e.g., 25 server instances).

Modified values of the fields 720-750 may be received from a user. The button 780 is operable to submit a modified sizing request. In response to detecting operation of the button 780, the load testing module 220 and the linear regression module 230 may perform load testing to update the data of FIGS. 3 and 4. Also, an updated version of the user interface 700 may be displayed that shows the instance information and number of instances for the modified sizing request.

The user may also modify values of the fields 760 and 770, changing the configuration of each server instance to be used for the application, the number of instances to be used by the application, or both. The button 790 is operable to deploy the application using the values currently displayed in the fields 760 and 770 (i.e., either the original values determined by the application server 130A or the modified values provided by the user).

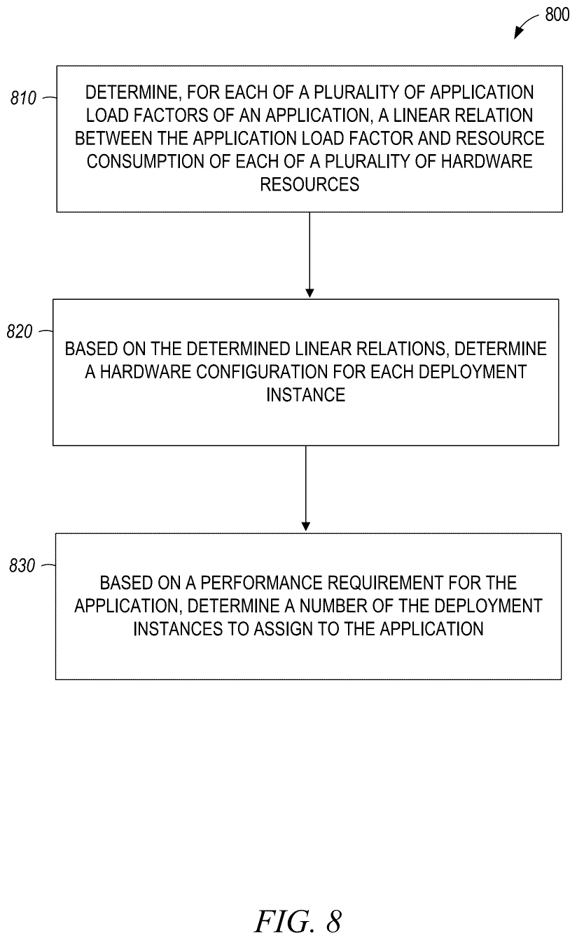

FIG. 8 shows a flowchart illustrating a method 800 of efficiently allocating hardware resources to software, according to some example embodiments. The method 800 includes operations 810, 820, and 830. By way of example and not limitation, the method 800 is described as being performed by the application server 130A of FIG. 1 in the computing environment 100 of FIG. 1, using the modules of FIG. 2, the data of FIGS. 3-5, and the user interfaces of FIGS. 6-7.

In operation 810, the linear regression module 230 determines, for each of a plurality of application load factors of an application, a linear relation between the application load factor and resource consumption of each of a plurality of hardware resources (e.g., a CPU, a memory, a network interface, a disk, or any suitable combination thereof). For example, with reference to FIG. 3, the application load factors may be a number of threads, a request size, and a data volume; the hardware resources may be a CPU and a memory. The resource consumption of the CPU may be a CPU utilization percentage and the resource consumption of the memory may be a memory utilization percentage. In other example embodiments, the hardware resources include a network, with a resource consumption of a utilization amount (e.g., measured in GB) or a utilization rate (e.g., measured in MB/s); a disk, with a resource consumption of a utilization amount (e.g., measured in TB) or a utilization rate (e.g., measured in MB/s); or any suitable combination thereof.

Continuing with the example data in FIG. 3, the linear relations are:

$$CPU \% Utilization = 4 + 3.2 \times Threads$$

$$MEM \% Utilization = 47 + 0.6 \times Threads$$

$$CPU \% Utilization = 12 + 0.8 \times Request Data$$

$$MEM \% Utilization = 45 + 0.5 \times Request Data$$

$$CPU \% Utilization = 18 + 4 \times Data Volume$$

$$MEM \% Utilization = 49 + 2 \times Data Volume$$

Alternatively, using the example data in FIG. 4, multiple linear regression may be used to determine the linear relations. For example, input variables for a number of threads, a size of request data, and a data volume may be used. As with simple linear regression, multiple linear regression can be summarized with a mathematic equation, such as the general form shown below.

$$Y = b 0 + b 1 X 1 + b 2 X 2 + b 3 X 3 … + b n X n$$

In this equation, Y is a continuous measurement outcome, b0 is the “intercept” or starting value, X1-Xn are the values of the independent predictor variables, and b1-bn are the coefficients for each independent variable. Applying this general form to the prediction of resource utilization, Y is a resource consumption measure of a hardware resource (e.g., CPU % utilization or MEM % utilization), X1-Xn are application load factors (e.g., number of threads as X1, request size as X2, and so on), and b0-bn are the values solved for by the multiple linear regression. Thus, once the b0-bn values are determined, the value of Y for any inputs X1-Xn may be estimated.

The determining of the linear relations wherein the determining of the linear relations may be based on a predetermined fraction (e.g., 1/100, 1/200, 1/500, 1/1000, 1/2000, 1/3000, 1/5000, or any other suitable fraction) of the performance requirement for the application. In the examples of FIGS. 3 and 6, the initial performance requirements used for each of the application load factors is 1/1000 of the user-provided target load parameters. Additionally, the step size for incrementing the load parameter between each test is 1/1000 of the user-provided target load parameter. Thus, the determining of the linear relations is based on tests performed using the predetermined fraction of the performance requirement for the application.

The resource allocation module 250, in operation 820, determines a hardware configuration for each deployment instance based on the determined linear relations. For example, the linear relations determined in operation 810 may be used to determine a relative load caused by each of the application load factors. Based on the determined linear relations and the relative loads, further testing, such as shown in FIG. 4 may be performed. Resources of the hardware deployment instance (e.g., CPU and memory) may be selected to synchronize the consumption of the resources. For example, if the tests reveal that CPU % utilization reaches a corresponding predetermined threshold (e.g., 90%) before MEM % utilization reaches its corresponding predetermined threshold (e.g., 80%), the hardware configuration may be modified to include less memory or a more powerful CPU.

The testing shown in FIG. 4 may be performed on a test server with a test configuration and, based on the results of the testing, the hardware configuration for the deployment instances selected from multiple available hardware configurations. For example, the test configuration may include a 4-core 3 GHz CPU with 32 GB of RAM. The available hardware configurations may include the test configuration, a configuration with a faster CPU and the same memory (e.g., an 8-core 4 GHz CPU with 32 GB of RAM), a configuration with the same CPU and more memory (e.g., a 4-core 3 GHz CPU with 64 GB of RAM), a configuration with a slower CPU and more memory (e.g., a 2-core 3 GHz CPU with 64 GB of RAM), a configuration with a faster CPU and less memory (e.g., an 8-core 4 GHz CPU with 16 GB of RAM), or any suitable combination thereof.

In operation 830, the resource allocation module 250, based on a performance requirement for the application, determines a number of the deployment instances to assign to the application. For example, the resource allocation module 250 may determine, for a specified request size and data volume (e.g., in the input fields 640 and 650), a number of threads that may be run per deployment instance. Dividing a specified number of threads (e.g., in the input field 630) by the number of threads per deployment instance, gives a number of deployment instances to assign to the application.

The results determined in operations 820 and 830 may be presented in the user interface 700. The user may accept the determined hardware resources to be allocated to the application by use of the button 790. Alternatively, the user may modify the determined hardware resources by use of the fields 760 and 770 before using the button 790.

For example, the user interface module 240 may receive, via the user interface, a modification to the number of deployment instances. In response to detecting operation of the button 790, the resource allocation module 250 allocates the resources to the application. The allocating of the resources to the application may include assigning, to the application, the modified number of deployment instances.

As another example, the user interface module 240 may receive, via the user interface, a modification to the hardware configuration. The allocating of the resources in response to detecting operation of the button 790 may include assigning, to the application, a deployment instance using the modified hardware configuration.

Thus, by use of the method 800, an application is efficiently sized and deployed. Accordingly, the need for modifying the hardware resources allocated to the application after deployment is reduced. Since modifying the assignment of resources after an application is deployed may involve downtime of the application or otherwise incur delays, the utility of the application to users is improved by the improved sizing.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: one or more hardware processors; and a memory device that stores instructions that, when executed by the one or more hardware processors, cause the one or more hardware processors to perform operations comprising: determining, for each of a plurality of application load factors of an application, a linear relation between the application load factor and resource consumption of each of a plurality of hardware resources; based on the determined linear relations, determining a hardware configuration for each deployment instance; and based on a performance requirement for the application, determining a number of the deployment instances to assign to the application.

In Example 2, the subject matter of Example 1, wherein the operations further comprise: causing a user interface to be presented that includes the number of the deployment instances; receiving, via the user interface, a modification to the number of deployment instances; and assigning, to the application, the modified number of deployment instances.

In Example 3, the subject matter of Examples 1-2, wherein the operations further comprise: causing a user interface to be presented that includes the hardware configuration; receiving, via the user interface, a modification to the hardware configuration; and assigning, to the application, a deployment instance using the modified hardware configuration.

In Example 4, the subject matter of Examples 1-3, wherein the plurality of application load factors of the application comprises a number of threads.

In Example 5, the subject matter of Examples 1-4, wherein the plurality of application load factors of the application comprises a size of request data.

In Example 6, the subject matter of Examples 1-5, wherein the plurality of application load factors of the application comprises a data volume.

In Example 7, the subject matter of Examples 1-6, wherein the plurality of hardware resources comprises a central processing unit (CPU) and the resource consumption of the CPU comprises a utilization percentage.

In Example 8, the subject matter of Examples 1-7, wherein the plurality of hardware resources comprises a memory and the resource consumption of the memory comprises a utilization percentage.

In Example 9, the subject matter of Examples 1-8, wherein the plurality of hardware resources comprises a network and the resource consumption of the network comprises a utilization amount.

In Example 10, the subject matter of Examples 1-9, wherein the plurality of hardware resources comprises a disk and the resource consumption of the disk comprises a utilization amount.

In Example 11, the subject matter of Examples 1-10, wherein the determining of the linear relations is based on a predetermined fraction of the performance requirement for the application.

In Example 12, the subject matter of Example 11, wherein the predetermined fraction is 1/100 or less.

In Example 13, the subject matter of Examples 11-12, wherein the predetermined fraction is 1/1000 or less.

In Example 14, the subject matter of Examples 1-13, wherein the determining of the number of the deployment instances includes using multiple linear regression with input variables for a number of threads, a size of request data, and a data volume.

Example 15 is a non-transitory computer-readable medium that stores instructions that, when executed by one or more processors, cause the one or more processors to perform operations comprising: determining, for each of a plurality of application load factors of an application, a linear relation between the application load factor and resource consumption of each of a plurality of hardware resources; based on the determined linear relations, determining a hardware configuration for each deployment instance; and based on a performance requirement for the application, determining a number of the deployment instances to assign to the application.

In Example 16, the subject matter of Example 15, wherein the operations further comprise: causing a user interface to be presented that includes the number of the deployment instances; receiving, via the user interface, a modification to the number of deployment instances; and assigning, to the application, the modified number of deployment instances.

In Example 17, the subject matter of Examples 15-16, wherein the operations further comprise: causing a user interface to be presented that includes the hardware configuration; receiving, via the user interface, a modification to the hardware configuration; and assigning, to the application, a deployment instance using the modified hardware configuration.

Example 18 is a method comprising: determining, by one or more processors and for each of a plurality of application load factors of an application, a linear relation between the application load factor and resource consumption of each of a plurality of hardware resources; based on the determined linear relations, determining a hardware configuration for each deployment instance; and based on a performance requirement for the application, determining a number of the deployment instances to assign to the application.

In Example 19, the subject matter of Example 18 includes causing a user interface to be presented that includes the number of the deployment instances; receiving, via the user interface, a modification to the number of deployment instances; and assigning, to the application, the modified number of deployment instances.

In Example 20, the subject matter of Examples 18-19 includes causing a user interface to be presented that includes the hardware configuration; receiving, via the user interface, a modification to the hardware configuration; and assigning, to the application, a deployment instance using the modified hardware configuration.

Example 21 is an apparatus comprising means to implement any of Examples 1-20.

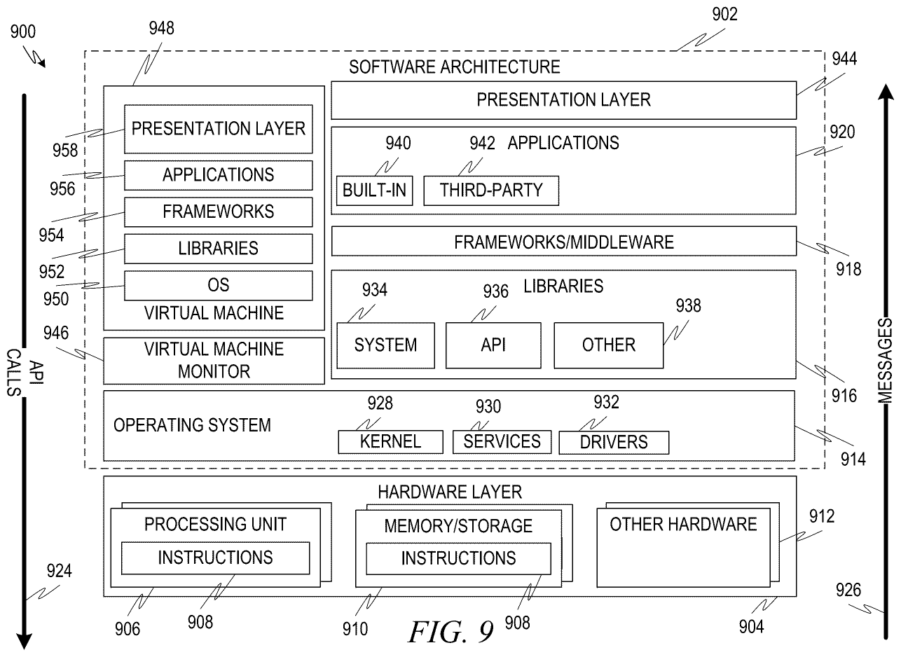

FIG. 9 shows a block diagram 900 showing one example of a software architecture 902 for a computing device. The software architecture 902 may be used in conjunction with various hardware architectures, for example, as described herein. FIG. 9 is merely a non-limiting example of a software architecture, and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 may provide a higher-level common infrastructure that may be utilized by the applications 920 and/or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications 940 as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), and frameworks/middleware 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine 948 as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 10 shows a block diagram of a machine in the example form of a computer system 1000 within which instructions 1024 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube [CRT]). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting a machine-readable medium 1022.

While the machine-readable medium 1022 is shown in FIG. 10 to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with the instructions 1024. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
one or more hardware processors; and
a memory device that stores instructions that, when executed by the one or more hardware processors, cause the one or more hardware processors to perform operations comprising:
determining, for each of a plurality of application load factors of an application, a linear relation between the application load factor and resource consumption of each of a plurality of hardware resources;
based on the determined linear relations, determining a hardware configuration for each deployment instance; and
based on a performance requirement for the application, determining a number of the deployment instances to assign to the application.

2. The system of claim 1, wherein the operations further comprise:
causing a user interface to be presented that includes the number of the deployment instances;
receiving, via the user interface, a modification to the number of deployment instances, resulting in a modified number of deployment instances; and
assigning, to the application, the modified number of deployment instances.

3. The system of claim 1, wherein the operations further comprise:
causing a user interface to be presented that includes the hardware configuration;
receiving, via the user interface, a modification to the hardware configuration, resulting in a modified hardware configuration; and
assigning, to the application, a deployment instance using the modified hardware configuration.

4. The system of claim 1, wherein the plurality of application load factors of the application comprises a number of threads.

5. The system of claim 1, wherein the plurality of application load factors of the application comprises a size of request data.

6. The system of claim 1, wherein the plurality of application load factors of the application comprises a data volume.

7. The system of claim 1, wherein the plurality of hardware resources comprises a central processing unit (CPU) and the resource consumption of the CPU comprises a utilization percentage.

8. The system of claim 1, wherein the plurality of hardware resources comprises a memory and the resource consumption of the memory comprises a utilization percentage.

9. The system of claim 1, wherein the plurality of hardware resources comprises a network and the resource consumption of the network comprises a utilization amount.

10. The system of claim 1, wherein the plurality of hardware resources comprises a disk and the resource consumption of the disk comprises a utilization amount.

11. The system of claim 1, wherein the determining of the linear relations is based on a predetermined fraction of the performance requirement for the application.

12. The system of claim 11, wherein the predetermined fraction is 1/100 or less.

13. The system of claim 11, wherein the predetermined fraction is 1/1000 or less.

14. The system of claim 1, wherein the determining of the number of the deployment instances includes using multiple linear regression with input variables for a number of threads, a size of request data, and a data volume.

15. A non-transitory computer-readable medium that stores instructions that, when executed by one or more processors, cause the one or more processors to perform operations comprising:
determining, for each of a plurality of application load factors of an application, a linear relation between the application load factor and resource consumption of each of a plurality of hardware resources;
based on the determined linear relations, determining a hardware configuration for each deployment instance; and
based on a performance requirement for the application, determining a number of the deployment instances to assign to the application.

16. The non-transitory computer-readable medium of claim 15, wherein the operations further comprise:
causing a user interface to be presented that includes the number of the deployment instances;
receiving, via the user interface, a modification to the number of deployment instances, resulting in a modified number of deployment instances; and
assigning, to the application, the modified number of deployment instances.

17. The non-transitory computer-readable medium of claim 15, wherein the operations further comprise:
causing a user interface to be presented that includes the hardware configuration;
receiving, via the user interface, a modification to the hardware configuration, resulting in a modified hardware configuration; and
assigning, to the application, a deployment instance using the modified hardware configuration.

18. A method comprising:
determining, by one or more processors and for each of a plurality of application load factors of an application, a linear relation between the application load factor and resource consumption of each of a plurality of hardware resources;
based on the determined linear relations, determining a hardware configuration for each deployment instance; and
based on a performance requirement for the application, determining a number of the deployment instances to assign to the application.

19. The method of claim 18, further comprising:
causing a user interface to be presented that includes the number of the deployment instances;
receiving, via the user interface, a modification to the number of deployment instances, resulting in a modified number of deployment instances; and
assigning, to the application, the modified number of deployment instances.

20. The method of claim 18, further comprising:
causing a user interface to be presented that includes the hardware configuration;
receiving, via the user interface, a modification to the hardware configuration, resulting in a modified hardware configuration; and
assigning, to the application, a deployment instance using the modified hardware configuration.
